(19) United States
(12) Patent Application Publication
(10) Pub. No.: US 2026/0346601 A1
(43) Pub. Date: Nov. 5, 2026

(54) INFORMATION PROCESSING APPARATUS, CONTROL METHOD THEREOF, AND STORAGE MEDIUM

(71) Applicant: CANON KABUSHIKI KAISHA, Tokyo (JP)

(72) Inventor: SATOSHI OKUMA, Ibaraki (JP)

(21) Appl. No.: 19/552,271

(22) Filed: Feb. 27, 2026

(30) Foreign Application Priority Data
Mar. 7, 2025 (JP) 2025-036693

(51) Int. Cl. B41F 33/00; G06V 10/98

(52) U.S. Cl. CPC B41F 33/0036; G06V 10/993

(57) ABSTRACT

An information processing apparatus comprising: one or more memory devices that store a set of instructions; and one or more processors that execute the set of instructions to: accept an input for inspecting an abnormality of an image in a printed material; and perform control of setting of a different value for each of a plurality of inspection levels respectively corresponding to a plurality of inspection regions, using the accepted input, wherein the one or more processors execute instructions in the one or more memory devices to set the plurality of inspection levels in such a manner as to maintain a magnitude relationship among the inspection levels.

### BACKGROUND

### Field of the Technology

The present disclosure relates to an information processing apparatus, a control method thereof, and a storage medium.

### Description of the Related Art

Conventionally, inspections for abnormalities such as soiling, scuffs, and the like on printed material printed by a printing apparatus have mainly been performed by visual inspection. However, inspection apparatuses that automatically perform such inspections as post-processing for printing apparatuses are being used in recent years. In such an inspection apparatus, reference image data serving as correct values for inspections is registered first. Next, submitted image data identical to the reference image data is printed out onto a sheet by the printing apparatus, and the printed material printed out onto the sheet is read by a reading apparatus provided inside the inspection apparatus. Inspection image data to be inspected is then generated. Abnormalities in the printed material are then detected by comparing this inspection image data with the reference image data that was registered first.

Settings regarding the details of the inspection are also set when registering the reference image data. The inspection region can be given as one such setting. The inspection region setting specifies which region in the reference image data is to be inspected. A plurality of regions can be set as inspection regions. Furthermore, a plurality of types of inspection regions can be set according to the rigor level of the inspection, such as “simple”, “standard”, and “critical”, for example. Which inspection type is to be set for which inspection region in the reference image data depends on the content of the reference image data. Generally speaking, regions where soiling and scuffs are more noticeable, such as photographs and illustrations, and regions that become difficult to read correctly when soiled, such as QR Codes (registered trademark), are set to “critical”, to ensure rigorous inspection. On the other hand, regions where only a certain level of readability need be ensured, such as text, are set to “standard”. Regions other than these, such as the background, are set to “simple”.

The inspection level is a stepwise value indicating the rigor of the inspection set in accordance with such inspection region types. For example, the inspection level is specified with an integer value from level 1 to level 9, where a more rigorous inspection is performed as the value increases. As the inspection becomes more rigorous, smaller or lighter levels of soiling and scuffing can be detected. If the inspection level is set too high, overdetection occurs, in which soiling is detected more often than necessary, which reduces the printing productivity. On the other hand, if the inspection level is too low, the abnormalities to be detected may not be successfully detected. The type of the inspection region is classified according to the rigor of the inspection, and it is therefore desirable that the inspection level conforms to the rigor of the inspection for the corresponding inspection region. Accordingly, regarding the inspection levels corresponding to the rigor of the “simple”, “standard”, and “critical” inspections, the inspection level is lowest for “simple” and highest for “critical”, with “standard” set to a value between the two. In such a case, each inspection level is specified according to the inspection levels for the other types of inspection regions.

Each inspection level can be set by operating an item such as a pull-down menu or a slide bar in a setting screen. Japanese Patent Laid-Open No. H7-36650 describes a technique in which, when making a setting by operating a plurality of slide bars, when one slider is moved in a predetermined direction, that slider makes contact with a part of another slider and pushes that slider in the same direction such that both sliders move simultaneously.

When a plurality of types of inspection regions are present as described above, the inspection level for each inspection region is constrained by the magnitude relationship with the inspection levels for the other inspection regions. For example, the inspection level for a “critical” region is set higher than the inspection levels for “standard” and “simple” regions. In other words, if the user wishes to set the inspection level for “standard” or “simple” regions higher than the inspection level for an existing “critical” region, the user updates the inspection level for the existing “critical” region to a new level higher than the inspection levels for “standard” and “simple” regions. However, in such a case, the user enters the new inspection level while confirming the magnitude relationship themselves. This places an increased burden on the user.

### SUMMARY

The present disclosure enables the realization of a technique that can reduce a burden on a user when setting an inspection level for a plurality of types of inspection regions when inspecting an image formed on printed material for abnormalities.

One aspect of the present disclosure provides n information processing apparatus comprising: one or more memory devices that store a set of instructions; and one or more processors that execute the set of instructions to: accept an input for inspecting an abnormality of an image in a printed material; and perform control of setting of a different value for each of a plurality of inspection levels respectively corresponding to a plurality of inspection regions, using the accepted input, wherein the one or more processors execute instructions in the one or more memory devices to set the plurality of inspection levels in such a manner as to maintain a magnitude relationship among the inspection levels.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram illustrating an image inspection system according to one embodiment.

FIG. 2 is a diagram illustrating the hardware configuration of an image forming apparatus according to one embodiment.

FIG. 3 is a diagram illustrating the hardware configuration of an inspection apparatus according to one embodiment.

FIG. 4 is a diagram illustrating a display screen according to one embodiment.

FIGS. 5A, 5B, and 5C are enlarged views of a display screen according to one embodiment.

FIG. 6 is a flowchart illustrating processing according to one embodiment.

FIG. 7 is a flowchart illustrating processing according to one embodiment.

FIG. 8 is a flowchart illustrating processing according to one embodiment.

FIGS. 9A, 9B, and 9C are enlarged views of a display screen according to one embodiment.

FIG. 10 is a flowchart illustrating processing according to one embodiment.

FIGS. 11A, 11B, and 11C are enlarged views of a display screen according to one embodiment.

FIG. 12 is a flowchart illustrating processing according to one embodiment.

FIGS. 13A, 13B, and 13C are enlarged views of a display screen according to one embodiment.

FIG. 14 is a flowchart illustrating processing according to one embodiment.

FIGS. 15A, 15B, and 15C are enlarged views of a display screen according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

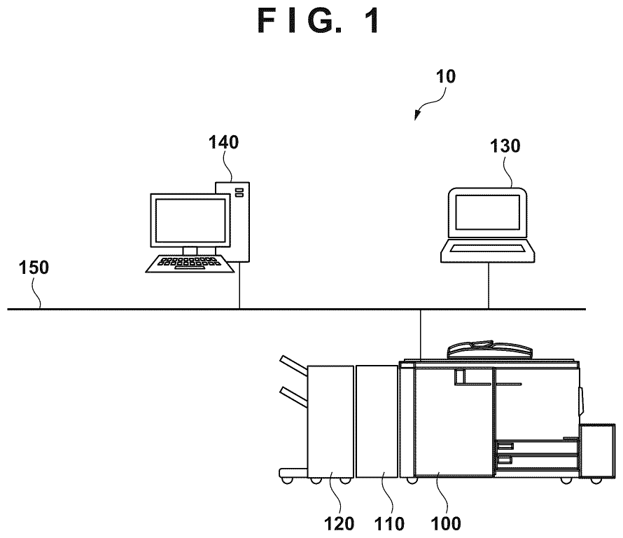

An overview of an image inspection system 10 according to a first embodiment will be described with reference to FIG. 1. The image inspection system 10 is configured including an image forming apparatus 100, an inspection apparatus 110, a finisher 120, a client PC 130, and a print server 140. The image forming apparatus 100, the client PC 130, and the print server 140 are connected over a network 150.

The image forming apparatus 100 prints using print data sent from the client PC 130, the print server 140, and the like. The inspection apparatus 110 receives a sheet of printed material output from the image forming apparatus 100 and inspects the received printed material for abnormalities. Here, “abnormality” refers to something that reduces the quality of the printed material, for example. More specifically, an “abnormality” is soiling caused by coloring material adhering to an unintended location when printing and color loss caused by insufficient coloring material adhering to an intended location. The finisher 120 receives the output sheet inspected by the inspection apparatus 110, switches the discharge destination in accordance with the result of the inspection by the inspection apparatus 110, performs additional post-processing such as bookbinding as necessary, and then discharges the sheet.

The image forming apparatus 100 is connected to the inspection apparatus 110 and the finisher 120 by communication cables. In addition to the image forming apparatus 100, the inspection apparatus 110 is connected to the finisher 120 by a communication cable. Note that FIG. 1 illustrates the configuration of an in-line inspection apparatus that performs image formation, inspection, post-processing, and discharge through an integrated process.

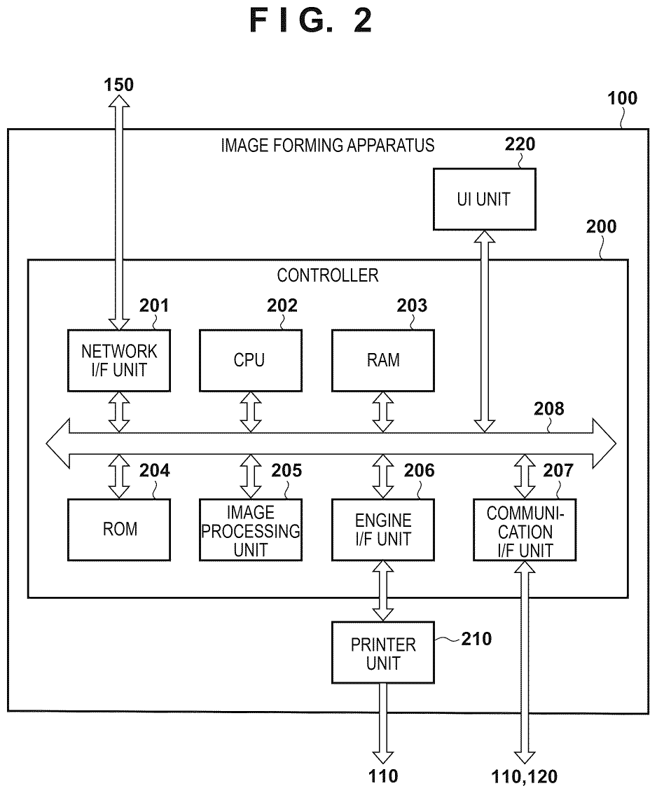

The hardware configuration of the image forming apparatus 100 will be described with reference to FIG. 2. The image forming apparatus 100 includes a controller 200, a printer unit 210, and a UI unit 220. The controller 200 receives image and document data over the network 150 and converts that data to print data. The printer unit 210 prints the print data on a recording medium such as various types of paper, sheets, and the like. The UI unit 220 is a user interface for a user to make instructions to the image forming apparatus 100 for sheet selection, print settings, and the like.

The configuration of the controller 200 will be described in detail next. The controller 200 is configured including a network I/F unit 201, a CPU 202, a RAM 203, a ROM 204, an image processing unit 205, an engine I/F unit 206, a communication I/F unit 207, and a system bus 208.

The network I/F unit 201 is configured including a communication module, and sends and receives various types of data to and from external devices over the network 150. The CPU 202 controls the processing of the image forming apparatus 100 as a whole. The RAM 203 is a memory that serves as a work area when the CPU 202 executes various types of commands. The ROM 204 is a memory that stores the data of programs executed by the CPU 202 at startup, settings data for the controller 200, and the like.

The image processing unit 205 performs Raster Image Processor (RIP) processing for converting the image and document data received over the network 150 into print data. More specifically, images and documents created on the client PC 130 or the print server 140 are sent as PDL data to the image forming apparatus 100 over the network 150. In the image forming apparatus 100, the PDL data that has been sent is stored in the RAM 203 through the network I/F unit 201. Printing instructions from the user made through the UI unit 220 are also stored in the RAM 203 through the system bus 208. The printing instructions made by the user include the selection of the sheet type, for example.

The image processing unit 205 then obtains the PDL data stored in the RAM 203 and performs image processing to convert that PDL data into print data. The image processing to convert the PDL data into print data is, for example, rasterizing the PDL data, converting the data into multivalue bitmap data, and then performing screen processing and the like, which converts the data into binary bitmap data. The binary bitmap data obtained by the image processing unit 205 is sent to the engine I/F unit 206. The engine I/F unit 206 receives the print data from the image processing unit 205 and sends the data to the printer unit 210. The communication I/F unit 207 is configured including a communication module, and communicates with the inspection apparatus 110 and the finisher 120. Each of these constituent elements of the controller 200 is provided on the system bus 208.

The printer unit 210 prints binary bitmap data received from the engine I/F unit 206 on a recording sheet using a coloring material. The CPU 202 issues instructions to the printer unit 210 using the printing instructions from the user stored in the RAM 203. For example, when an instruction to print on coated paper is received from the user, the CPU 202 instructs a sheet to be fed toward the printer unit 210 from a sheet cassette (not shown) holding coated paper in the image forming apparatus 100. The various processing from receiving the stated PDL data to printing onto a sheet is controlled by the CPU 202 to form a full-color toner image on the sheet.

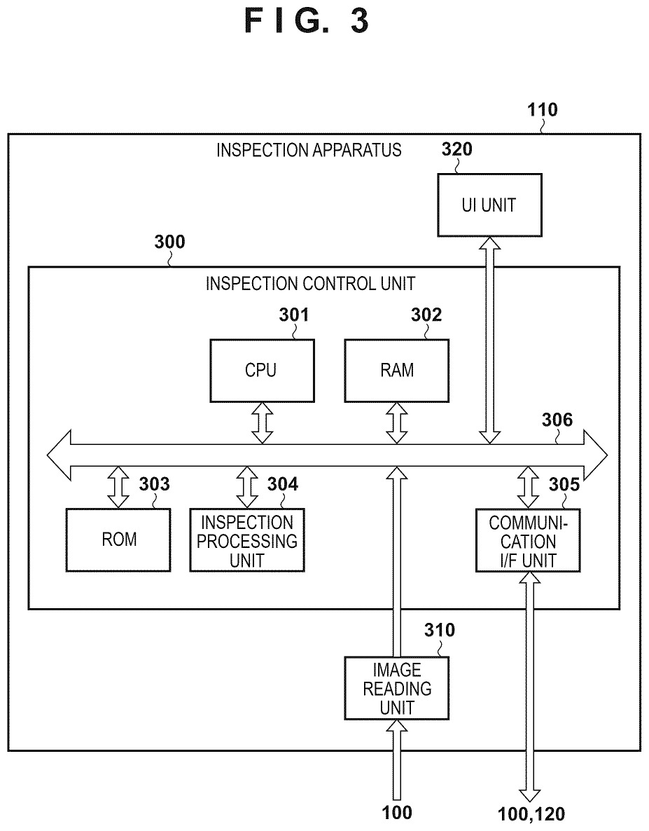

The hardware configuration of the inspection apparatus 110 will be described with reference to FIG. 3. The inspection apparatus 110 is configured including an inspection control unit 300, an image reading unit 310, and a UI unit 320 (an example of a “display unit”). The inspection control unit 300 controls the inspection apparatus 110 as a whole, and inspects printed materials for abnormalities. The image reading unit 310 reads a printed material conveyed from the image forming apparatus 100. The UI unit 320 is a user interface through which the user makes settings for the inspection apparatus 110, and which displays inspection results. The settings for the inspection apparatus 110 made by the user are, for example, settings for inspection items when inspecting a printed material, such as what kind of abnormalities to inspect for and the rigor of the inspection. The presence or absence of round abnormalities (spots) or linear abnormalities (streaks), for example, is determined by setting such inspection items.

The configuration of the inspection control unit 300 will be described in detail next. The inspection control unit 300 includes a CPU 301, a RAM 302, a ROM 303, an inspection processing unit 304, a communication I/F unit 305, and a system bus 306.

The CPU 301 controls the processing of the inspection apparatus 110 as a whole. The RAM 302 is a memory that serves as a work area when the CPU 301 executes various types of commands. The RAM 302 also stores setting values for performing inspections. The ROM 303 is a memory that stores the data of programs executed by the CPU 301 at startup, settings data for the inspection control unit 300, and the like. The inspection processing unit 304 inspects printed materials for abnormalities. The communication I/F unit 305 is configured including a communication module, and communicates with the image forming apparatus 100 and the finisher 120. Each of these constituent elements of the inspection control unit 300 is provided on the system bus 306.

An overview of printed image inspection performed by the inspection apparatus 110 will be described next. The CPU 301 of the inspection apparatus 110 obtains a scanned image of an inspection target by using the image reading unit 310 to read a printed material conveyed from the image forming apparatus 100. The obtained scanned image of the inspection target is stored in the RAM 302. Then, using the inspection processing unit 304, the CPU 301 calculates a difference value between a reference image, which is stored in the RAM 302 in advance as a correct image, and the scanned image of the inspection target.

Next, the CPU 301 performs the inspection by comparing the calculated difference value with inspection thresholds (e.g., contrast and size) for each inspection item on a pixel-by-pixel basis. The inspection result is stored in the RAM 302. The inspection result is, for example, information on whether an abnormality is present in the printed material, the type of abnormality detected (spot or streak), the location of the abnormality when the inspection result is displayed on the UI unit 320, and the like.

Next, the CPU 301 instructs the UI unit 320 to display the inspection result stored in the RAM 302. Displaying the inspection result on the UI unit 320 enables the user to confirm the inspection result. When a certain number of printed materials containing abnormalities have occurred in succession, the CPU 301 uses the communication I/F unit 305 to send abnormality occurrence information on the abnormalities to the image forming apparatus 100. The controller 200 of the image forming apparatus 100 then receives the abnormality occurrence information using the communication I/F unit 207. When the controller 200 receives the abnormality occurrence information, the CPU 202 instructs the printer unit 210 to stop printing. The image forming apparatus 100 stops the printing operations by instructing the printer unit 210 to stop printing.

Furthermore, the CPU 301 of the inspection apparatus 110 sends the inspection result stored in the RAM 302 to the finisher 120 using the communication I/F unit 305. The inspection result sent to the finisher 120 is information indicating whether the printed material contains an abnormality, for example. Using the received inspection result, the finisher 120 discharges printed materials that do not contain abnormalities to a normal discharge tray, and discharges printed materials that contain abnormalities to a tray different from the normal discharge tray.

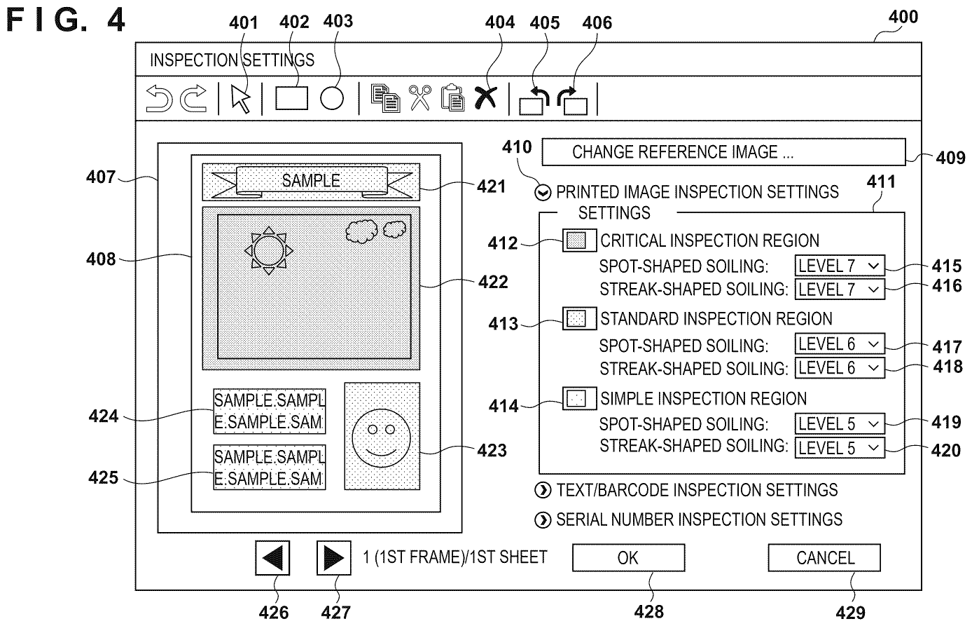

An inspection settings screen 400 displayed on the UI unit 320 of the inspection apparatus 110 will be described with reference to FIG. 4. The inspection settings screen 400 is a screen for setting the image inspection performed by the inspection apparatus 110, and is displayed on the UI unit 320. The user makes advanced settings for the image inspection performed by the inspection apparatus 110 in the inspection settings screen 400.

More specifically, the inspection settings screen 400 includes a selection button 401, a quadrangular region designation button 402, a circular region designation button 403, a region deletion button 404, a left rotation button 405, a right rotation button 406, a display region 407, and a reference image 408. The selection button 401 is a button for selecting an inspection region that has already been set. In other words, by operating the selection button 401, the user can select an existing inspection region displayed in the reference image 408.

The quadrangular region designation button 402 is a button for creating a new quadrangular inspection region. When the user presses the quadrangular region designation button 402, options are displayed for choosing whether to create a critical inspection region, a standard inspection region, or a simple inspection region. When the user selects one such inspection region, the selected type of inspection region can be created in the reference image 408. Although three types of inspection regions have been illustrated as options, it is sufficient for at least two types of inspection regions to be provided as options.

The circular region designation button 403 is a button for creating a new circular inspection region. As with the quadrangular region designation button 402, when the user presses the circular region designation button 403, options are displayed for choosing whether to create a critical inspection region, a standard inspection region, or a simple inspection region. When the user then selects one such inspection region, the selected type of inspection region can be created in the reference image 408.

The region deletion button 404 is a button for deleting an inspection region that has already been set. A selected inspection region can be deleted by the user by pressing the region deletion button 404. The left rotation button 405 is a button for rotating the reference image 408 displayed in the display region 407 counterclockwise by 90 degrees. The right rotation button 406 is a button for rotating the reference image 408 displayed in the display region 407 clockwise by 90 degrees. The reference image 408 is an image serving as a reference for inspection, and is an image saved in the RAM 302 in advance as a correct image. The display region 407 is a region for displaying the reference image 408.

The inspection settings screen 400 also includes an image change button 409 and an inspection region settings button 410. The image change button 409 is a button for changing the reference image displayed in the display region 407. The inspection region settings button 410 is a button for displaying an inspection region settings screen 411. The inspection region settings button 410 is a toggle button for switching between displaying and hiding the inspection region settings screen 411.

The inspection region settings screen 411 is a screen for setting the inspection level, indicating the rigor of the inspection, in an inspection setting region, for each type of inspection region. The inspection region settings screen 411 includes settings information for a plurality of types of inspection regions. In the example illustrated in FIG. 4, inspection settings for three inspection regions are possible, namely a region for a critical inspection (“critical region” hereinafter), a region for a standard inspection (“standard region” hereinafter), and a region for a simple inspection (“simple region” hereinafter).

Furthermore, the inspection level, indicating the rigor of the inspection, can be set for each type of abnormality to inspect for in each inspection region. FIG. 4 illustrates two types of abnormalities to be inspected for, namely spot-shaped soiling and streak-shaped soiling. The user can set the inspection level for each type of abnormality independently through the inspection region settings screen 411. In the example illustrated in FIG. 4, the inspection level can be specified as an integer in 9 stages, from 1 to 9. The rigor of the inspection increases with the magnitude of the value of the inspection level. Here, the “rigor” of the inspection refers to how small and light soiling is before it is detected as an abnormality, for example. As the rigor increases, smaller and lighter soiling can be detected, and whether that soiling is abnormal can be determined.

Additionally, the inspection level for a given type of abnormality in a given type of inspection region is not independent from the inspection level for the same type of abnormality in another type of inspection region, and is instead constrained by a predetermined magnitude relationship. For example, the inspection level for spot-shaped soiling in critical regions is constrained to a level higher than the inspection level for spot-shaped soiling in standard regions. Furthermore, the inspection level for spot-shaped soiling in standard regions is constrained to a level higher than the inspection level for spot-shaped soiling in simple regions, for example. In other words, the inspection levels for spot-shaped soiling and streak-shaped soiling in critical regions, standard regions, and simple regions are constrained such that the values increase in the order of simple regions, standard regions, and critical regions. On the other hand, the inspection levels for different types of abnormalities in the same inspection region can be set independently without any constraints. In other words, the inspection levels for spot-shaped soiling and streak-shaped soiling in a critical region can be set independently from each other, for example.

More specifically, the inspection region settings screen 411 includes a critical region identifier 412, a standard region identifier 413, and a simple region identifier 414. The inspection region settings screen 411 also includes spot-shaped soiling inspection level setting pull-downs (415, 417, and 419) and streak-shaped soiling inspection level setting pull-downs (416, 418, and 420).

The critical region identifier 412 indicates a region in which the same fill pattern as a critical region set in the reference image 408 is displayed. The standard region identifier 413 indicates a region in which the same fill pattern as a standard region set in the reference image 408 is displayed. The simple region identifier 414 indicates a region in which the same fill pattern as a simple region set in the reference image 408 is displayed. The spot-shaped soiling inspection level setting pull-downs (415, 417, and 419) are pull-down menus for setting spot-shaped soiling inspection levels in critical regions, standard regions, and simple regions, respectively. The streak-shaped soiling inspection level setting pull-downs (416, 418, and 420) are pull-down menus for setting streak-shaped soiling inspection levels in critical regions, standard regions, and simple regions, respectively.

The inspection region settings screen 411 also includes inspection regions 421 to 425, a previous page button 426, a next page button 427, an OK button 428, and a cancel button 429. The inspection regions 421 to 425 indicate examples of inspection regions set on the reference image 408 using the quadrangular region designation button 402. An inspection is performed for each inspection region by comparing the reference image with the inspection image. The image inspection is performed in each inspection region in accordance with the inspection level set for that inspection region.

More specifically, a critical inspection region 422 is filled with the same pattern as the fill pattern indicated by the critical region identifier 412, and the inspection is performed at the inspection levels set by the inspection level setting pull-downs (415 and 416). Standard inspection regions (421 and 423) are filled with the same pattern as the fill pattern indicated by the standard region identifier 413, and the inspection is performed at the inspection levels set by the inspection level setting pull-downs (417 and 418). Simple inspection regions (424 and 425) are filled with the same pattern as the fill pattern indicated by the simple region identifier 414, and the inspection is performed at the inspection levels set by the inspection level setting pull-downs (419 and 420). Note that a plurality of inspection regions of the same type can be created, such as standard inspection regions (421 and 423) and simple inspection regions (424 and 425).

Which type of inspection region to set at which position in the reference image 408 can be determined by the user in accordance with the content of the reference image. Inspection regions can also be set to partially overlap. When different types of inspection regions overlap, the inspection having the higher inspection level is executed.

The previous page button 426 is a button for, when the reference image 408 includes a plurality of frames, displaying the reference image from the frame previous to the reference image displayed. The next page button 427 is a button for, when the reference image 408 includes a plurality of frames, displaying the reference image from the frame after the reference image displayed.

The OK button 428 is a button for confirming the values of the various settings displayed in the inspection settings screen 400 as setting values and closing the screen. Note that these setting values are saved in the RAM 302. The cancel button 429 is a button for canceling the values of the various settings displayed in the inspection settings screen 400, without confirming the values as setting values, and closing the screen.

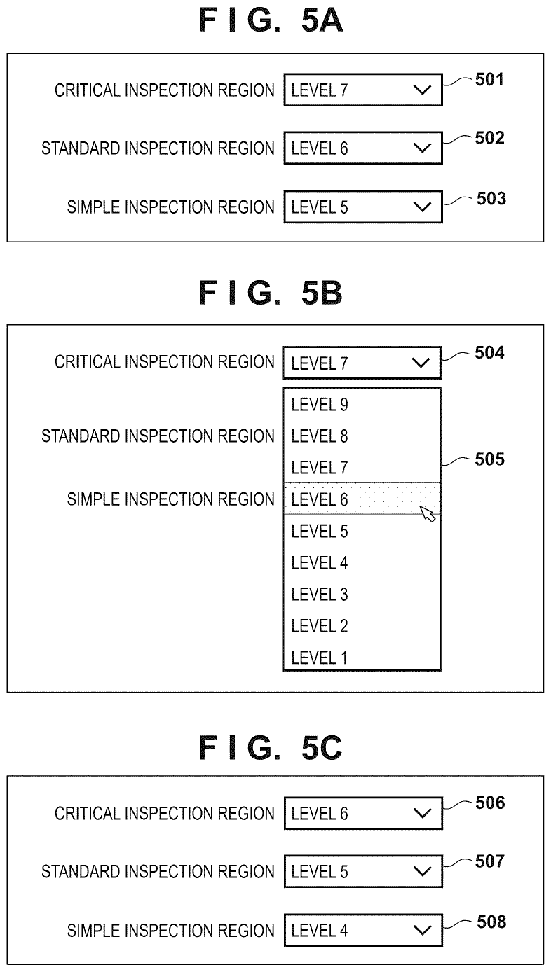

A method for setting the inspection level in the inspection settings screen 400 will be described with reference to FIGS. 5A to 5C. FIGS. 5A to 5C illustrate partial enlarged views of the inspection level setting pull-downs (415, 417, and 419) for spot-shaped soiling in the inspection region settings screen 411 of the inspection settings screen 400. Note that FIG. 5A may indicate the inspection level setting pull-downs for streak-shaped soiling (416, 418, and 420). Note that in the following descriptions, the pull-downs related to the inspection levels for the critical inspection regions will also be referred to as “critical inspection level setting pull-downs” regardless of the type of abnormality that is the inspection target. Likewise, the pull-downs related to the inspection levels for the standard inspection regions will also be referred to as “standard inspection level setting pull-downs”, and the pull-downs related to the inspection levels for the simple inspection regions will also be referred to as “simple inspection level setting pull-downs”.

FIG. 5A illustrates the default state of the inspection level setting pull-down for each inspection region. The inspection levels for each inspection region are, from highest to lowest, a critical inspection level, a standard inspection level, and a simple inspection level. In other words, FIG. 5A illustrates an example of a state in which a critical inspection level setting pull-down 501 is set to level 7, a standard inspection level setting pull-down 502 is set to level 6, and a simple inspection level setting pull-down 503 is set to level 5. As mentioned earlier, the inspection level can be set to an integer value in nine stages, from 1 to 9.

FIG. 5B illustrates an example of a state in which the user has pressed the critical inspection level setting pull-down 501 in the state illustrated in FIG. 5A to change the critical inspection level, and an option menu for the critical inspection level has been displayed. When the user presses the critical inspection level setting pull-down 501 in this manner, an inspection level setting menu 505 is displayed under a critical inspection level setting pull-down 504. The user can then select one of the options in the inspection level setting menu 505. Note that the inspection level setting menu 505 is an example of a “first object that displays selectable inspection levels in list format”.

Here, the options displayed in the inspection level setting menu 505 are displayed in a state in which all the values that can be set as inspection levels, i.e., levels 1 to 9, are selectable. The display is not limited to the critical inspection level setting pull-down 501, however. Similarly, when the standard inspection level setting pull-down 502 or the simple inspection level setting pull-down 503 is pressed, all levels 1 to 9 are displayed in a selectable state.

FIG. 5C illustrates an example of the screen after the user selects the option for “level 6” from the inspection level setting menu 505 in the state illustrated in FIG. 5B. A critical inspection level setting pull-down 506 displays level 6, selected by the user. A standard inspection level setting pull-down 507 and a simple inspection level setting pull-down 508 are automatically changed to level 5 and level 4, respectively, and displayed, such that the inspection level magnitude relationship with the critical inspection is satisfied by each. Note that this change is also determined to satisfy the magnitude relationship between the inspection levels of the standard inspection and the simple inspection.

Here, if, in the state illustrated in FIG. 5B, the user selects the option for “level 1” from the inspection level setting menu 505, the display of the critical inspection level setting pull-down is automatically changed to level 3, for example. Furthermore, the standard inspection level setting pull-down is automatically changed to level 2, and the simple inspection level setting pull-down is automatically changed to level 1. This is because when the critical region inspection level is level 1, the inspection levels of the standard inspection region and the simple inspection region cannot be determined in a manner that satisfies the magnitude relationship with the inspection level of the critical region. Accordingly, the critical region inspection level is re-set to level 3, which is the minimum value at which the magnitude relationship with the inspection levels of the standard inspection region and the simple inspection region is satisfied. Furthermore, the inspection level of the standard region is re-set to level 2, and the inspection level of the simple region is re-set to level 1.

Additionally, if, in the state illustrated in FIG. 5B, the user selects the option for “level 9” from the inspection level setting menu 505, the display of the critical inspection level setting pull-down is changed to level 9. On the other hand, the display of the standard inspection level setting pull-down is kept at level 6, and the display of the simple inspection level setting pull-down is kept at level 5. This is because when the inspection level of the critical region is changed from level 7 to level 9, the magnitude relationships with the inspection levels of the standard region and the simple region remain satisfied. There is thus no need to change the inspection level of the standard region and the inspection level of the simple region.

In this manner, when the user wishes to change the inspection level of any inspection region, they freely select the inspection level of the desired inspection region without considering the magnitude relationships of the inspection levels of each region. Once the user has selected the inspection level of any inspection region, the inspection level of each inspection region is automatically re-set taking into account the magnitude relationships. It is therefore easy to set the inspection levels for a plurality of regions for which the magnitude relationships are constrained.

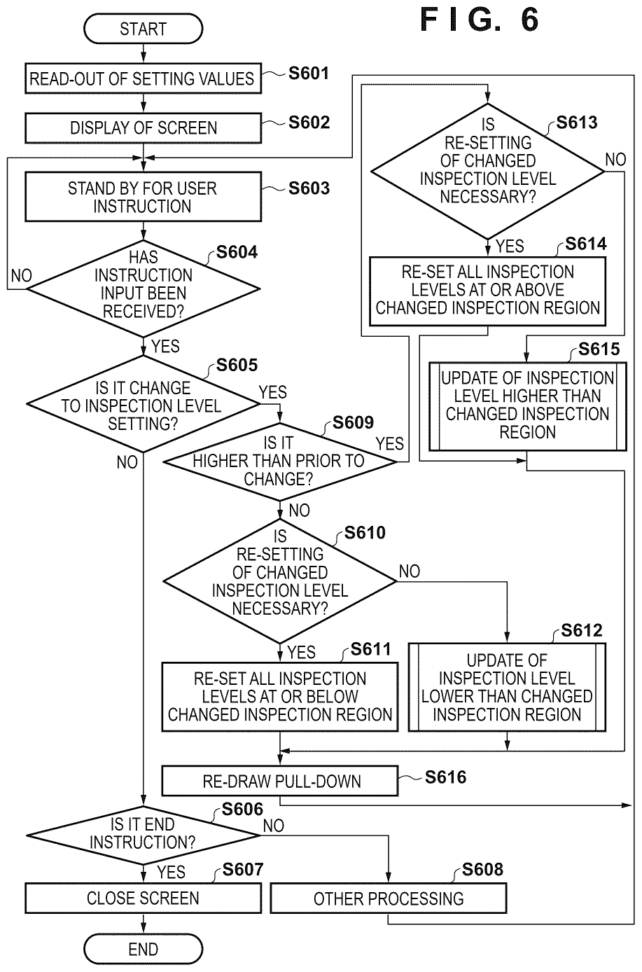

Processing for setting the inspection levels in the first embodiment will be described with reference to FIG. 6. Note that each step in the flowchart in FIG. 6 is processed by the CPU 301 executing a control program stored in the ROM 303 of the inspection apparatus 110. Processing through which the inspection settings screen 400 is displayed in response to an instruction from the user and the screen is closed after the inspection level is set will be described here.

In step S601, the CPU 301 of the inspection apparatus 110 accepts an instruction to display the inspection settings screen 400 from the user using the UI unit 320. The CPU 301 then reads out information such as the setting values set in the inspection settings screen 400 from the ROM 303 or the RAM 302. In step S602, the CPU 301 generates the inspection settings screen 400 in a state where the respective setting values are set according to the information read out in step S601. The CPU 301 then displays the inspection settings screen 400 in the UI unit 320.

In step S603, the CPU 301 stands by for a predetermined length of time for an instruction to be input by the user through the UI unit 320. In step S604, the CPU 301 determines whether an instruction has been input through the UI unit 320. If the CPU 301 determines that an instruction has been input, the sequence moves to step S605, and if not, the sequence returns to step S603.

In step S605, the CPU 301 determines whether the instruction input by the user includes an instruction to change the inspection level setting. More specifically, in a state where the inspection level setting menu 505 of any inspection region is displayed as illustrated in FIG. 5B, whether an inspection level has been selected from among the options in the inspection level setting menu 505 is determined. If the CPU 301 determines that the inspection level has changed, the sequence moves to step S609.

In step S609, the CPU 301 determines whether the selected inspection level is higher than the inspection level prior to the change. If the CPU 301 determines that the selected inspection level is higher, the sequence moves to step S613, and if not, the sequence moves to step S610. In step S610, the CPU 301 determines whether it is necessary to re-set the changed inspection level. If the CPU 301 determines that it is necessary to re-set the changed inspection level, the sequence moves to step S611.

More specifically, the CPU 301 determines whether the inspection level of an inspection region that normally should be set to be relatively higher than the inspection levels of other types of inspection regions has been selected as a lower value than the inspection levels of the other types of inspection regions. The CPU 301 then determines whether to re-set the selected inspection level to a higher value in order to maintain the magnitude relationships with the inspection levels of the other types of inspection regions. Examples of the inspection level being re-set include when the inspection level of the critical region is set to level 2 or lower, or when the inspection level of the standard region is set to level 1.

A mathematical formula expressing this determination method is as follows. First, N is taken as the number of types of inspection regions, and n is taken as a natural number, starting from 1, that includes the number of the inspection region by counting in order from the inspection region having the lowest inspection level. In the first embodiment, N=3 and n=1 to 3. Lₙ is an integer representing the inspection level set in the n-th inspection region. In the first embodiment, Lₙ can be a value of 1 to 9.

The maximum value that the inspection level can take is represented by MAX(L), and the minimum value that the inspection level can take is represented by MIN(L). However, the inspection level can be changed while maintaining the magnitude relationships among the inspection regions, and is therefore MAX(L)−MIN(L)≥N. In this example, MAX(L)=9 and MIN(L)=1. At this time, if the inspection level of the inspection region that has been changed is Lₙ, it is determined that it is necessary to re-set the inspection level when Lₙ satisfies Lₙ<MIN(L)+n−1.

The descriptions will now return to the flowchart in FIG. 6. In step S611, the CPU 301 re-sets (updates) the inspection level of the inspection region for which the inspection level has been changed and inspection regions for which the inspection level has become relatively lower. For example, when the inspection level of the standard region is changed to 1, it is necessary to maintain the magnitude relationship between the inspection level of the standard region and the inspection level of the simple region. Accordingly, the CPU 301 re-sets the inspection level of the standard region to 2 and the inspection level of the simple region to 1.

These settings can also be described according to the foregoing formula. In other words, for all instances of Lᵢ for which i is no greater than n, the CPU 301 sets the inspection level Lᵢ for the i-th inspection region in order from the lowest inspection level such that Lᵢ=MIN(L)+i−1. The sequence then moves to step S616. In step S616, the CPU 301 displays, in the UI unit 320, the inspection settings screen 400 including the pull-downs in which the inspection levels of all the re-set inspection regions are rendered. The sequence then returns to step S603.

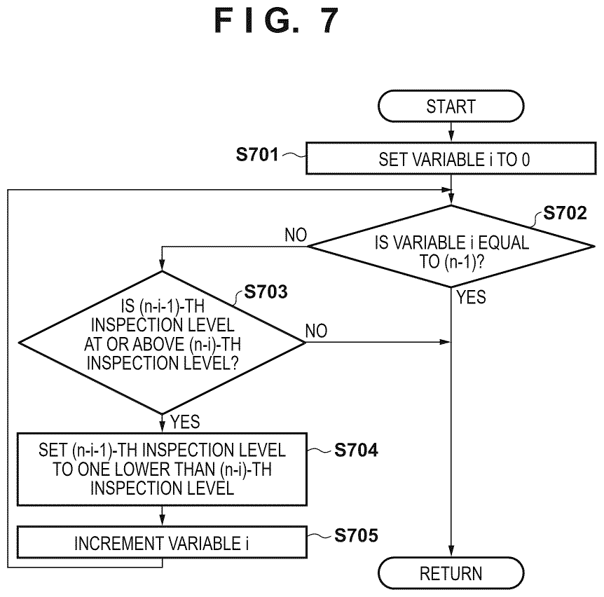

On the other hand, if in step S610 the CPU 301 determines that it is not necessary to re-set the selected inspection level, the sequence moves to step S612. In step S612, the CPU 301 re-sets the inspection level for the inspection region for which the inspection level will become relatively lower than the inspection region for which the inspection level has been changed. More specifically, in the state illustrated in FIG. 5A, the CPU 301 receives the selection of level 6 for the inspection level of the critical region. Then, the CPU 301 re-sets the inspection level of the standard region to level 5 and re-sets the inspection level of the simple region to level 4. The specific method for this processing will be described later with reference to FIG. 7. The sequence then moves to step S616, after which the sequence returns to step S603.

In step S613, the CPU 301 determines whether it is necessary to re-set the changed inspection level. If the CPU 301 determines that it is necessary to re-set the inspection level, the sequence moves to step S614, and if not, the sequence moves to step S615.

More specifically, it is determined whether the inspection level of an inspection region that normally should be set to be relatively lower than the inspection levels of other types of inspection regions has been selected as a higher value than the inspection levels of other types of inspection regions. The CPU 301 then determines whether to re-set the selected inspection level to a lower value in order to maintain the magnitude relationships with the inspection levels of the other types of inspection regions. Examples of the inspection level being re-set include when the inspection level of the simple region is set to at least level 8, or when the inspection level of the standard region is set to level 9.

A mathematical formula expressing this determination method is as follows. That is, if the inspection level of the inspection region that has been changed is Lₙ, it is determined that it is necessary to re-set the inspection level when Lₙ satisfies Lₙ>MAX(L)−N+n.

The descriptions will now return to the flowchart in FIG. 6. In step S614, the CPU 301 re-sets the inspection level for the inspection region for which the inspection level has been changed, and for the inspection region for which the inspection level will become relatively higher. For example, when the inspection level of the standard region has been changed to 9, it is necessary to maintain the magnitude relationship between the inspection level of the standard region and the inspection level of the critical region. Accordingly, the CPU 301 re-sets the inspection level of the standard region to 8 and the inspection level of the critical region to 9.

These settings can also be described according to the foregoing formula. In other words, for all instances of Lᵢ for which i is at least n, the CPU 301 sets the inspection level Lᵢ for the i-th inspection region in order from the lowest inspection level such that Lᵢ=MAX(L)+i−N. The sequence then moves to step S616, after which the sequence returns to step S603.

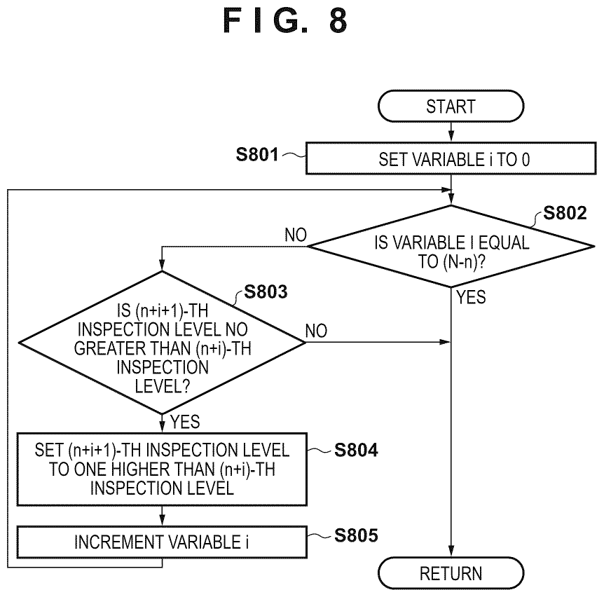

In step S615, the CPU 301 re-sets the inspection level for the inspection region for which the inspection level will become relatively higher than the inspection region for which the inspection level has been changed. The specific method for this processing will be described later with reference to FIG. 8. The sequence then moves to step S616, after which the sequence returns to step S603.

In step S606, the CPU 301 determines whether the instruction input from the UI unit 320 is an end instruction for the inspection settings screen 400. Specifically, the end instruction is the OK button 428 or the cancel button 429 of the inspection settings screen 400 illustrated in FIG. 4 being pressed. If the CPU 301 determines that the instruction input is an end instruction for the inspection settings screen 400, the sequence moves to step S607, and if not, the sequence moves to step S608.

In step S608, the CPU 301 performs processing such as receiving other setting value changes in the inspection settings screen 400, making display instructions to the UI unit 320, and the like. In other words, such processing includes processing for generating or deleting inspection regions, processing such as moving through pages of reference images, processing for redrawing screens, and the like, for example. The sequence then returns to step S603.

In step S607, the CPU 301 closes the inspection settings screen 400. At this time, when the CPU 301 receives an instruction as a result of the OK button 428 being pressed, the temporary setting values set when the inspection settings screen 400 is displayed are overwritten and saved in the RAM 302 as the correct setting values. However, when the CPU 301 receives an instruction as a result of the cancel button 429 being pressed, the temporary setting values are not saved in the RAM 302. The sequence then ends.

A flowchart illustrating the processing performed in step S612 of FIG. 6 will be described next with reference to FIG. 7. Like the flowchart in FIG. 6, each step in the flowchart in FIG. 7 is processed by the CPU 301 executing a control program stored in the ROM 303.

In step S701, the CPU 301 sets an internal variable i to 0. In step S702, whether the variable i is equal to (n−1) is determined. Here, n is a natural number, starting from 1, which indicates the number of the inspection region for which the inspection level is determined to have been changed, counting from the inspection region having the lowest inspection level, in step S605, in the same manner as described with reference to FIG. 6. If the variable i is determined to be equal to (n−1), the sequence moves to step S616 of the flowchart in FIG. 6, and if not, the sequence moves to step S703.

In step S703, the CPU 301 determines whether the inspection level of the (n−i −1)-th inspection region, counting from the inspection region having the lowest inspection level, is a value that is at least the inspection level of the (n−i)-th inspection region. In other words, expressed using the formula described with reference to FIG. 6, the CPU 301 determines whether Lₙ−i−1≥Lₙ−i is satisfied. If the CPU 301 determines that the inspection level of the (n−i−1)-th inspection region is at least the inspection level of the (n−i)-th inspection region, the sequence moves to step S704, and if not, the sequence moves to step S616 of the flowchart in FIG. 6.

In step S704, the CPU 301 sets the inspection level of the (n−i−1)-th inspection region to one lower than the inspection level of the (n−i)-th inspection region (an example of “an inspection region for which the inspection level is one level higher”). For example, if n=3 and i=0, when the inspection level of the (n−i−1)-th, i.e., the second inspection region is 6, and the inspection level of the (n−i)-th, i.e., the third inspection region is the same 6, the inspection level of the second inspection region is set to 5. Such processing is also illustrated in FIGS. 5A to 5C. In other words, when the inspection level of the critical region is set to 6, the inspection level of the standard region is re-set from 6 to 5 and displayed, as illustrated in FIG. 5C, for example. In step S705, the CPU 301 increments the value of the variable i by 1. The sequence then returns to step S702, and the steps described above are repeated.

A flowchart illustrating the processing performed in step S615 of FIG. 6 will be described next with reference to FIG. 8. Like the flowchart in FIG. 6, each step in the flowchart in FIG. 8 is processed by the CPU 301 executing a control program stored in the ROM 303.

In step S801, the CPU 301 sets the internal variable i to 0. In step S802, the CPU 301 determines whether the variable i is equal to (N−n). Here, n is a natural number, starting from 1, which indicates the number of the inspection region for which the inspection level is determined to have been changed, counting from the inspection region having the lowest inspection level, in step S605 of FIG. 6, in the same manner as described with reference to FIG. 6. N is a number indicating the type of the inspection region. If the variable i is determined to be equal to (N−n), the sequence moves to step S616 of the flowchart in FIG. 6, and if not, the sequence moves to step S803.

In step S803, the CPU 301 determines whether the inspection level of the (n+i +1)-th inspection region, counting from the inspection region having the lowest inspection level, is no greater than the inspection level of the (n+i)-th inspection region. In other words, expressed using the formula described with reference to FIG. 6, the CPU 301 determines whether Lₙ+i+1≤Lₙ+i is satisfied. If the CPU 301 determines that the inspection level of the (n+i+1)-th inspection region is no greater than the inspection level of the (n+i)-th inspection region, the sequence moves to step S804, and if not, the sequence moves to step S616 of the flowchart in FIG. 6.

In step S804, the CPU 301 sets the inspection level of the (n+i+1)-th inspection region to one higher than the inspection level of the (n+i)-th inspection region (an example of “an inspection region for which the inspection level is one level lower”). For example, if n=1 and i=0, when the inspection level of the (n+i+1)-th, i.e., the second inspection region is 6, and the inspection level of the (n+i)-th, i.e., the first inspection region is the same 6, the inspection level of the second inspection region is set to 7. Through such processing, if, for example, the inspection level of the simple region is set to 6 in the initial state in FIG. 5A, the inspection level of the standard region is re-set from 6 to 7 and displayed. In step S805, the CPU 301 increments the value of the variable i by 1. The sequence then returns to step S802, and the steps described above are repeated.

### Actions and Effects

According to the image inspection system 10 according to the first embodiment, when setting a plurality of inspection levels having magnitude relationships which are constrained, the user can select any inspection level displayed in the inspection level setting menu 505 of the inspection settings screen 400. If it is necessary to re-set the inspection level to maintain the magnitude relationships, the re-setting is executed automatically. This makes it possible to lighten the burden on the user for setting the inspection levels for a plurality of types of inspection regions for which the magnitude relationships are constrained.

### Second Embodiment

The general configuration of an image inspection system according to a second embodiment is the same as that described in the first embodiment. The second embodiment will therefore mainly describe differences from the first embodiment. In the second embodiment, when setting the inspection levels of a plurality of inspection regions, a pull-down that makes it easy for the user to intuitively recognize the constraints of the setting values of the respective inspection levels is displayed.

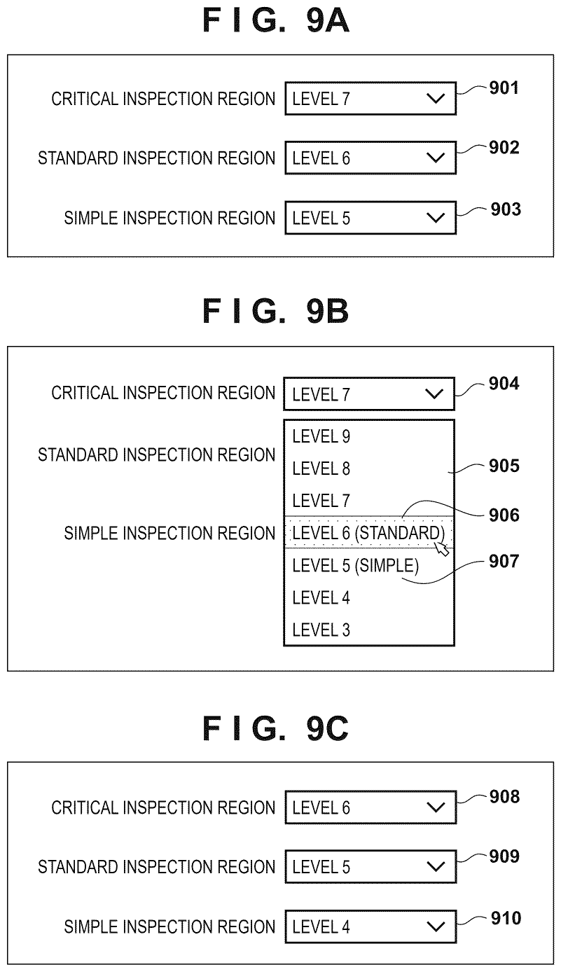

An inspection level setting method using an inspection settings screen according to the second embodiment will be described with reference to FIGS. 9A to 9C. Like FIGS. 5A to 5C, FIGS. 9A to 9C illustrate partial enlarged views of the inspection level setting pull-downs for spot-shaped soiling in the inspection region settings screen 411 of the inspection settings screen 400.

Like FIG. 5A, FIG. 9A illustrates the default state of the inspection level setting pull-down for each inspection region. Like FIG. 5A, the pull-downs illustrated in FIG. 9A indicate level 7 for a critical inspection level setting pull-down 901, level 6 for a standard inspection level setting pull-down 902, and level 5 for a simple inspection level setting pull-down 903.

FIG. 9B illustrates an example of a state in which the user has pressed the critical inspection level setting pull-down 901 in the state illustrated in FIG. 9A to change the critical inspection level, and an option menu for the critical inspection level has been displayed. When the user presses the critical inspection level setting pull-down 901 in this manner, an inspection level setting menu 905 is displayed under a critical inspection level setting pull-down 904. The user can then select one of the options in the inspection level setting menu 905 and input a desired inspection level.

Here, the options displayed in the inspection level setting menu 905 are displayed in a state in which the values from the minimum value to the maximum value which can be set as the critical inspection level are selectable. In other words, the critical inspection level is constrained to inspection levels 3 to 9 in the magnitude relationships with the standard inspection level and the simple inspection level. Accordingly, the levels are displayed in the inspection level setting menu 905 so as to already be constrained to values from 3 to 9.

Similarly, when the user presses the standard inspection level setting pull-down 902, values from levels 2 to 8 are displayed as options. When the user presses the simple inspection level setting pull-down 903, values from levels 1 to 7 are displayed as options.

In addition, as illustrated in FIG. 9B, an identifier indicating the inspection level of another inspection region in a set state is displayed in the inspection level setting menu 905 for the critical inspection. An identifier 906 is an identifier indicating the setting value of the standard inspection level. More specifically, the standard inspection level is set to level 6. Accordingly, the identifier 906 is displayed as text reading “(standard)” next to the option of level 6, for example. Likewise, an identifier 907 is an identifier indicating the setting value of the simple inspection level. Here, the simple inspection level is set to level 5. Accordingly, the identifier 907 is displayed as text reading “(simple)” next to the option of level 5, for example.

In this manner, inspection levels other than those for the inspection region to be set are displayed in the menu 905 so as to be easily visually identifiable. Through this, the user can easily understand how much changing the inspection level of the inspection region to be set will result in the levels of the other inspection regions being changed when the inspection level is selected. Note that the identifiers (906 and 907) are not limited to text such as “(standard)” and “(simple)”, and may be expressed as symbols, colors, patterns, or the like. The identifiers (906 and 907) are an example of a “second object”. The critical inspection region having the text 9(B) is an example of a “first predetermined inspection region”.

FIG. 9C illustrates an example of the state after the user selects the option for “level 6” from the inspection level setting menu 905 in the state illustrated in FIG. 9B. A critical inspection level setting pull-down 908 displays level 6, selected by the user. A standard inspection level setting pull-down 909 and a simple inspection level setting pull-down 910 are automatically changed to level 5 and level 4, respectively, such that the inspection level magnitude relationship with the critical inspection is satisfied by each. Note that this change is also determined to satisfy the magnitude relationship between the inspection levels of the standard inspection and the simple inspection.

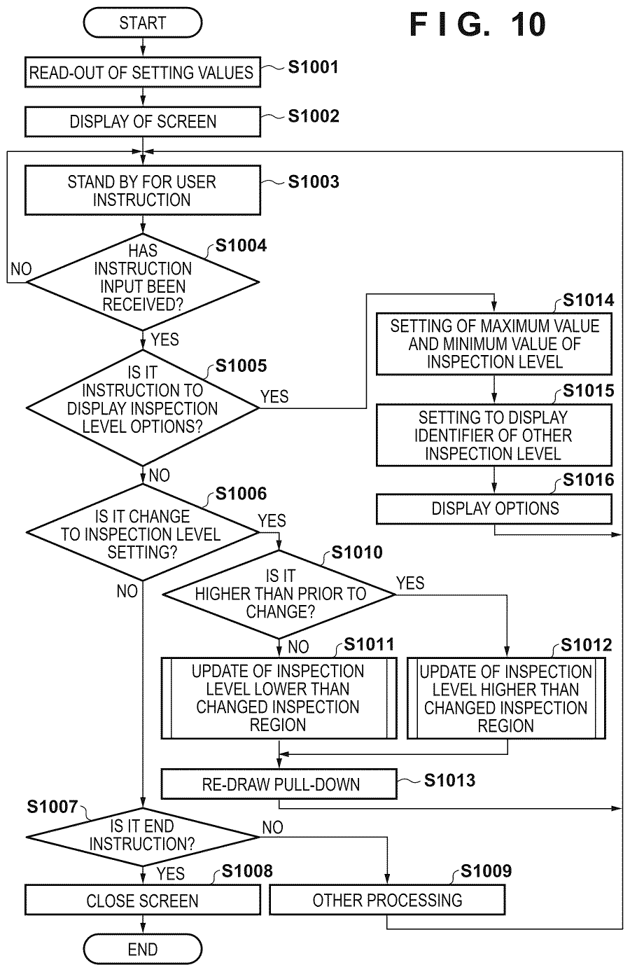

Processing for setting the inspection levels in the second embodiment will be described with reference to FIG. 10. Note that each step in the flowchart in FIG. 10 is processed by the CPU 301 executing a control program stored in the ROM 303.

Steps S1001 to S1004 are the same as steps S601 to S604 of FIG. 6 according to the first embodiment, and will therefore not be described. If in step S1004 the CPU 301 determines that an instruction input has been received, the sequence moves to step S1005. In step S1005, the CPU 301 determines whether the instruction input is an instruction to display inspection level options. More specifically, the CPU 301 determines whether the inspection level setting pull-down for any of the inspection regions has been pressed from the state illustrated in FIG. 9A. If the CPU 301 determines that the instruction input is an instruction to display inspection level options, the sequence moves to step S1014.

In step S1014, the CPU 301 calculates the minimum value and the maximum value for the inspection level that, substantially, can be set for the selected inspection region. For example, if the instruction input is an instruction to display options for the inspection level of the critical inspection region, the CPU 301 calculates 3 as the minimum value and 9 as the maximum value, as illustrated in FIG. 9B. Generalized using the formulas described above, the maximum value and the minimum value can be expressed as follows. The minimum value=MIN(L)+n−1. The maximum value=MAX(L)+n−N.

In step S1015, the CPU 301 adds an identifier indicating the setting values for the inspection levels of the other types of inspection regions to the inspection level setting menu. In other words, when the inspection level setting menu for the critical inspection level is displayed as illustrated in FIG. 9B, identifiers (906 and 907) indicating the setting values for the standard inspection level and the simple inspection level are added to the inspection level setting menu 905.

In step S1016, the CPU 301 displays the inspection level setting menu in the UI unit 320. The inspection levels included in the inspection level setting menu are values constrained to values between the maximum value and the minimum value calculated in step S1014. The identifiers added in step S1015 are also included in the inspection level setting menu. The sequence then returns to step S1003.

On the other hand, if in step S1005 the CPU 301 determines that the instruction input is not an instruction to display inspection level options, the sequence moves to step S1006. Step S1006 is the same as step S605 in the first embodiment. If the CPU 301 makes a determination of “YES” in step S1006, the sequence moves to step S1010, and if not, the sequence moves to step S1007. Step S1010 is the same as step S609 in the first embodiment. If the CPU 301 makes a determination of “YES” in step S1010, the sequence moves to step S1012, and if not, the sequence moves to step S1011.

Step S1011 is the same as step S612 in the first embodiment. After step S1011 is executed, the sequence moves to step S1013. Step S1012 is the same as step S615 in the first embodiment. After step S1012 is executed, the sequence moves to step S1013. Step S1013 is the same as step S616 in the first embodiment. After step S1013 is executed, the sequence returns to step S1003.

The processing of steps S1007 to S1009 is the same as steps S606 to S608 in the first embodiment, and will therefore not be described. After step S1009 is executed, the sequence returns to step S1003. Furthermore, after step S1008 is executed, the sequence ends.

### Actions and Effects

According to the image inspection system 10 according to the second embodiment, when setting the inspection levels of a plurality of inspection regions, constraints placed on the input values by the magnitude relationships among the respective inspection levels and the setting values of the inspection levels of the other inspection regions are displayed to the user in an easily-recognizable manner. This enables the user to set the inspection levels while easily understanding the relationships among the respective inspection levels of the plurality of inspection regions. This in turn makes it possible to lighten the burden on the user for setting the inspection levels for a plurality of types of inspection regions for which the magnitude relationships are constrained.

### Third Embodiment

The configuration of the image inspection system according to a third embodiment is the same as in the first and second embodiments, and thus differences from the first and second embodiments will mainly be described. The third embodiment describes an example of a slide bar through which the user can easily view the magnitude relationships among a plurality of types of inspection regions when setting the inspection levels.

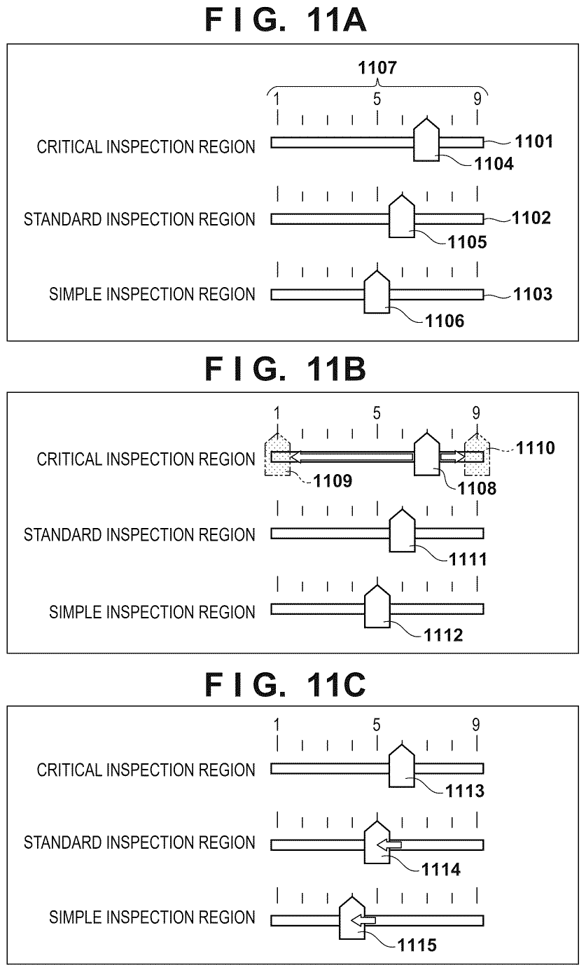

A method for setting the inspection level in the inspection settings screen will be described with reference to FIGS. 11A to 11C. The first and second embodiments described examples of pull-downs for setting the inspection levels, the third embodiment will describe an example of a slide bar for setting the inspection levels as an alternative to the pull-downs. FIGS. 11A to 11C illustrate a screen in which the inspection level setting pull-downs (415, 417, and 419) for spot-shaped soiling in the corresponding inspection regions in the inspection region settings screen 411 are replaced by sliders. As in the first embodiment, these sliders may be applied to the inspection level setting pull-downs (416, 418, and 420) for streak-shaped soiling as well. Note that the slide bars will also be referred to as a “critical inspection level setting slide bar”, a “standard inspection level setting slide bar”, or a “simple inspection level setting slide bar” hereinafter, regardless of whether the soiling is spot-shaped soiling or streak-shaped soiling.

FIG. 11A illustrates the default state of the inspection level setting slide bar for each inspection region. The inspection region settings screen 411 includes sliders for setting an inspection level for each region (1104, 1105, and 1106), as well as slide bars (1101, 1102, and 1103) indicating the ranges over which the sliders (1104, 1105, and 1106) can move. The inspection region settings screen 411 also includes a slide bar scale 1107 indicating the inspection levels that can be set. The sliders (1104, 1105, and 1106) are an example of a “third object”. The slide bars (1101, 1102, and 1103) are an example of “a single straight line”.

As in the first and second embodiments, the inspection levels are constrained such that the values increase in the order of simple regions, standard regions, and critical regions. FIG. 11A illustrates an example of a state in which the critical inspection level setting slider 1104 is set to level 7, the standard inspection level setting slider 1105 is set to level 6, and the simple inspection level setting slider 1106 is set to level 5. The slide bar scale 1107 indicates that the inspection level can be set to 9 stages, from 1 to 9, as in the first and second embodiments.

The critical inspection level setting slider 1104, the standard inspection level setting slider 1105, and the simple inspection level setting slider 1106 can be moved on each slide bar by the user performing an operation, such as dragging, to make an instruction. Furthermore, when the dragging operation by the user ends, each slider is automatically disposed at a position aligned with a tick on the slide bar scale 1107, rather than being disposed between ticks.

FIG. 11B illustrates an example of a state in which, from the state illustrated in FIG. 11A, the user drags a critical inspection level setting slider 1108 in order to change the critical inspection level. At this time, the critical inspection level setting slider 1108 can be moved to any desired value from inspection level 1 to inspection level 9. In other words, the user can move the slider 1108 to the position of any tick on the scale from a slider position 1109 to a slider position 1110. Likewise, the user can also move a standard inspection level setting slider 1111 and a simple inspection level setting slider 1112 to the position of any tick on the scale from the slider position 1109 to the slider position 1110.

FIG. 11C illustrates an example of the state after the user has finished dragging a critical inspection level setting slider 1113 from the state illustrated in FIG. 11B to the position of inspection level 6. At this time, a standard inspection level setting slider 1114 and a simple inspection level setting slider 1115 are automatically changed to the positions of level 5 and level 4, respectively, such that the inspection level magnitude relationship with the critical inspection is satisfied by each.

Incidentally, assume that, from the state illustrated in FIG. 11B, the user has set the critical inspection level setting slider 1108 to inspection level 1, i.e., the slider position 1109, and has finished the dragging. In such a case, the critical inspection level setting slider 1113 is automatically changed to the position of level 3, the standard inspection level setting slider 1114 is automatically changed to the position of level 2, and the simple inspection level setting slider 1115 is automatically changed to the position of level 1.This is because, as in the first embodiment, when the critical inspection level is level 1,the critical inspection level cannot satisfy the magnitude relationships with the standard inspection level and the simple inspection level. Accordingly, the critical inspection level is re-set to level 3, which is the minimum value at which the magnitude relationships are satisfied. Then, the standard inspection level is re-set to level 2, and the simple inspection level is re-set to level 1.

Additionally, assume that, from the state illustrated in FIG. 11B, the user has set the critical inspection level setting slider 1108 to inspection level 9, i.e., the slider position 1110, and has finished the dragging. In such a case, the critical inspection level setting slider is set to level 9, but the standard inspection level setting slider remains at level 6,and the simple inspection level setting slider remains at level 5. This is because the magnitude relationships among the critical inspection level, the standard inspection level, and the simple inspection level are maintained even when the critical inspection level is changed from level 7 to level 9. Therefore, the standard inspection level and the simple inspection level are not changed. In this manner, when changing the inspection level of any type of inspection region, the user does not need to consider the magnitude relationships among the inspection levels in the respective regions.

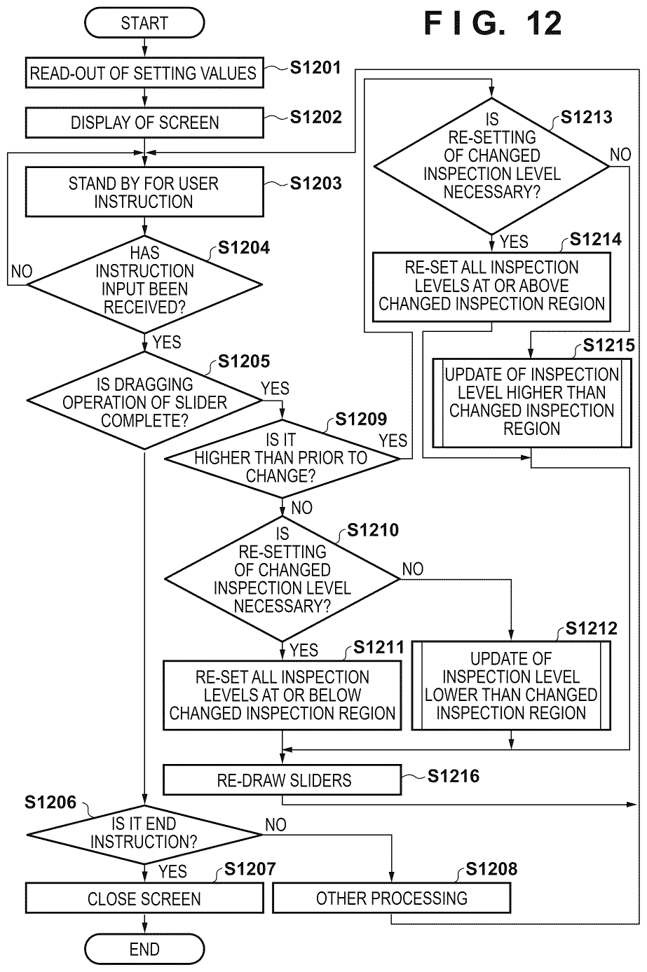

Processing for setting the inspection levels in the third embodiment will be described with reference to FIG. 12. Each step in the flowchart in FIG. 12 is processed by the CPU 301 executing a control program stored in the ROM 303.

Steps S1201 to S1204 are the same as steps S601 to S604 of FIG. 6 according to the first embodiment, and will therefore not be described. However, in step S1202, the displayed inspection settings screen 400 includes slide bars as illustrated in FIGS. 11A to 11C.

In step S1205, the CPU 301 determines whether an operation for dragging the inspection level setting slider in the corresponding region is complete. When the CPU 301 determines that the dragging operation is complete, the sequence moves to step S1209. Specifically, the CPU 301 detects that a mouse button, a finger, or the like has been released while any one of the inspection level setting sliders illustrated in FIG. 11B is being dragged. Upon making such a detection, the CPU 301 determines that the dragging operation is complete.

Steps S1209 to S1215 are the same as steps S609 to S615 of FIG. 6 according to the first embodiment, and will therefore not be described. The sequence moves to step S1216 after steps S1211, S1212, S1214, and S1215 are executed. In step S1216, the CPU 301 re-draws the sliders for all the re-set inspection regions. The sequence then returns to step S1203.

On the other hand, when in step S1205 the CPU 301 determines that the dragging operation is not yet complete, the sequence moves to step S1206. Steps S1206 to S1208 are the same as steps S606 to S608 in FIG. 6, and will therefore not be described. After step S1208 is executed, the sequence returns to step S1203. Furthermore, after step S1207 is executed, the sequence ends.

### Actions and Effects

According to the image inspection system 10 of the third embodiment, the same effects as those of the first embodiment can be achieved. Furthermore, having the user manipulate sliders that enable the magnitude relationships among the inspection levels to be viewed easily makes it possible to further lighten the burden on the user.

### Fourth Embodiment

The general configuration of an image inspection system according to a fourth embodiment is the same as that described in the first embodiment. The fourth embodiment will therefore mainly describe differences from the first to third embodiments. The fourth embodiment will describe an example of slide bars that make it easy for the user to intuitively recognize the constraints of the setting values of the respective inspection levels being displayed when setting the inspection levels of a plurality of types of inspection regions.

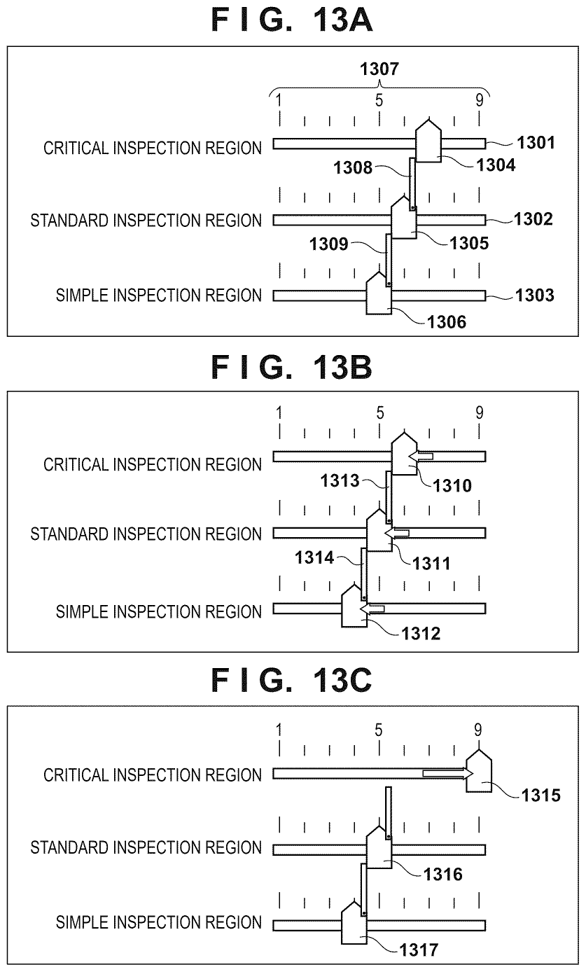

An inspection level setting method using an inspection settings screen according to the fourth embodiment will be described with reference to FIGS. 13A to 13C. In the fourth embodiment, the inspection level can be set by the user operating sliders, in the same manner as in the third embodiment. Furthermore, like FIGS. 11A to 11C, FIGS. 13A to 13C illustrate a screen in which the inspection level setting pull-downs (415, 417, and 419) for spot-shaped soiling in the corresponding inspection regions in the inspection region settings screen 411 are replaced by sliders. As in the first embodiment, these sliders may be applied to the inspection level setting pull-downs (416, 418, and 420) for streak-shaped soiling as well. Note that the slide bars will also be referred to as a “critical inspection level setting slide bar”, a “standard inspection level setting slide bar”, or a “simple inspection level setting slide bar” hereinafter, regardless of whether the soiling is spot-shaped soiling or streak-shaped soiling.

FIG. 13A illustrates the default state of the inspection level setting slide bar for each inspection region. As in the third embodiment, the inspection levels are constrained such that the values increase in the order of simple regions, standard regions, and critical regions. FIG. 13A illustrates an example of a state in which a critical inspection level setting slider 1304 is set to level 7, a standard inspection level setting slider 1305 is set to level 6, and a simple inspection level setting slider 1306 is set to level 5. A slide bar scale 1307 indicates that the inspection level can be set to 9 stages, from 1 to 9, as in the third embodiment.

The critical inspection level setting slider 1304, the standard inspection level setting slider 1305, and the simple inspection level setting slider 1306 can be moved on each slide bar by the user performing an operation, such as dragging, to make an instruction. Furthermore, when the dragging operation by the user ends, each slider is automatically disposed at a position aligned with a tick on the slide bar scale 1307, rather than being disposed between ticks. Furthermore, the standard inspection level setting slider 1305 and the simple inspection level setting slider 1306 are provided with interference bars (1308 and 1309) indicating physical interference with the other sliders. The interference bars (1308 and 1309) are an example of a “fourth object”. The critical inspection region in FIGS. 13A to 13C is an example of a “second predetermined inspection region”.

Assume that in the screen illustrated in FIG. 13A, the user drags the slider 1304 to move the slider 1304 to the left, i.e., moves the slider 1304 so as to lower the inspection level. In this case, the interference bar 1308 moves toward the left side of the screen and physically pushes the slider 1305 for setting the standard inspection level. Furthermore, as a result of moving the slider 1305 to the left, the interference bar 1309 moves toward the left side of the screen and physically pushes the slider 1306 for setting the simple inspection level. On the other hand, if, in the screen illustrated in FIG. 13A, the user drags the slider 1304 for setting the critical inspection level to move the slider 1304 to the right, the inspection level is set higher. In such a case, the slider 1305 is not subject to physical interference by the interference bar 1308. As such, only the slider 1304 moves toward the right side of the screen.

FIG. 13B illustrates an example of a state in which the user drags a slider 1310 to the left from the state illustrated in FIG. 13A so as to lower the critical inspection level. At this time, a slider 1311 for setting the standard inspection level is subjected to physical interference from an interference bar 1313 and, like the slider 1310, moves toward the left side of the screen. As a result of moving the slider 1311 to the left, a slider 1312 for setting the simple inspection level also moves to the left due to physical interference from an interference bar 1314. The magnitude relationships among the setting sliders are maintained by having the setting sliders move simultaneously due to the physical interference from the interference bars (1313 and 1314).

FIG. 13C illustrates an example of a state in which the user has dragged the slider 1310 from the state illustrated in FIG. 13B to the position of inspection level 9. At this time, only the slider 1310 (displayed as a slider 1315 in FIG. 13C) moves, and a slider 1316 for setting the standard inspection level and a slider 1317 for setting the simple inspection level do not move. This is because when the inspection level of the critical region is changed from level 6 to level 9, the magnitude relationships between the inspection level of the critical region and the inspection levels of the standard region and the simple region are maintained. Therefore, the inspection level of the standard region and the inspection level of the simple region are not changed. In this manner, the interference bars are displayed such that interference among the sliders does not occur during movement of sliders in which the magnitude relationship of the respective inspection levels is maintained.

In this manner, the sliders move so as to maintain their positional relationships with each other. The user can therefore set a desired inspection level while confirming the values of the other inspection levels. Additionally, displaying interference bars that produce physical interference among the sliders enables the user to intuitively recognize the influence on other inspection levels.

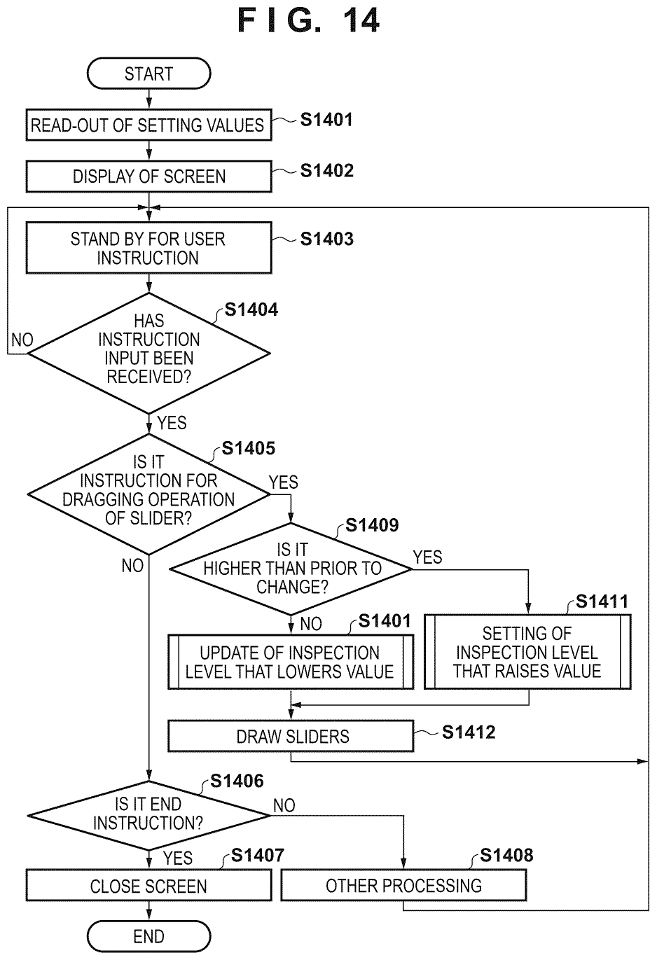

Processing for setting the inspection levels in the fourth embodiment will be described with reference to FIG. 14. Each step in the flowchart in FIG. 14 is processed by the CPU 301 executing a control program stored in the ROM 303.

Steps S1401 to S1404 are the same as steps S1201 to S1204 of FIG. 12 according to the third embodiment, and will therefore not be described. However, interference bars such as those illustrated in FIGS. 13A to 13C are included in the screen displayed in step S1402.

In step S1405, the CPU 301 determines whether the instruction input is an operation of dragging a slider to instruct the setting of the inspection level of each region. Specifically, the CPU 301 determines whether a dragging operation of the slider for setting any of the inspection levels in FIGS. 13A to 13C is an operation for moving the slider. If the CPU 301 determines that the instruction input is an instruction for a dragging operation of the slider, the sequence moves to step S1409.

Steps S1409 to S1411 are the same as steps S1010 to S1012 of the flowchart of FIG. 10 according to the second embodiment, and will therefore not be described. After steps S1410 and S1411 are executed, the sequence moves to step S1412. In step S1412, the CPU 301 re-draws the sliders for setting the inspection levels of all the inspection regions that have been re-set. The sequence then returns to step S1403.

On the other hand, if in step S1405 the CPU 301 determines that the instruction input is not an instruction for a dragging operation of the slider, the sequence moves to step S1406. The processing of steps S1406 to S1408 are the same as steps S1206 to S1208 of the flowchart of FIG. 12 according to the third embodiment, and will therefore not be described. After step S1408 is executed, the sequence returns to step S1403. Furthermore, after step S1407 is executed, the sequence ends.

### Actions and Effects

According to the image inspection system 10 of the fourth embodiment, the same effects as those of the third embodiment can be achieved. Furthermore, according to the fourth embodiment, settings can be made while intuitively understanding the influence that changes in one inspection level have on the setting values of other inspection levels. This makes it possible to further lighten the burden on the user.

### Fifth Embodiment

The general configuration of an image inspection system according to a fifth embodiment is the same as that described in the first embodiment. The fifth embodiment will therefore mainly describe differences from the first to fourth embodiments. The fifth embodiment will describe an example of slide bars that make it easy for the user to intuitively recognize the constraints of the setting values resulting from the magnitude relationships among the respective inspection levels when setting the inspection levels of a plurality of types of inspection regions.

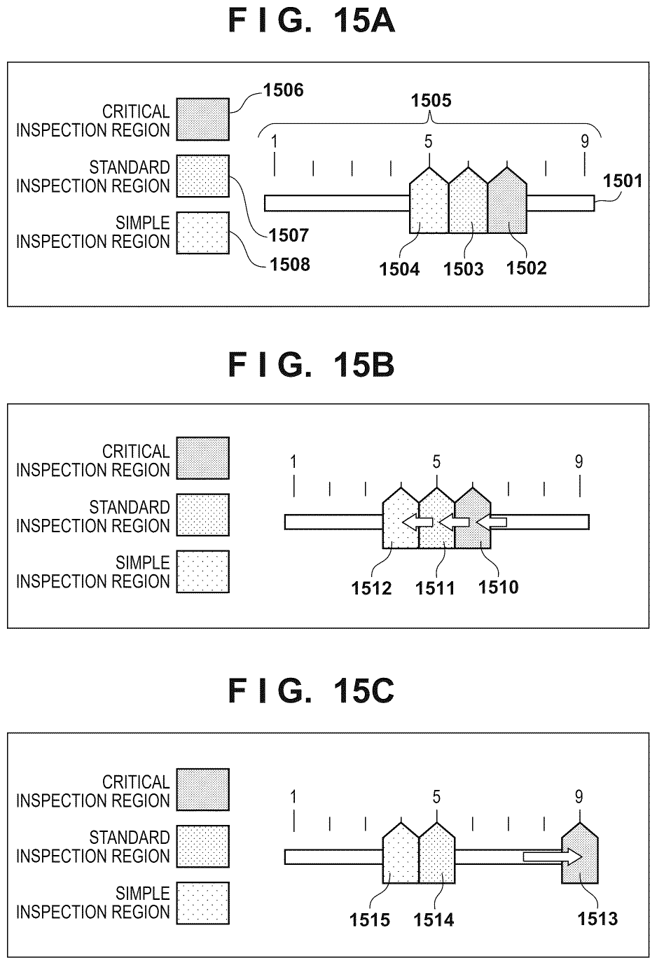

An inspection level setting method using an inspection settings screen according to the fifth embodiment will be described with reference to FIGS. 15A to 15C. Like the third and fourth embodiments, the fifth embodiment will describe an example of a method for setting the inspection levels using slide bars. Furthermore, like FIGS. 13A to 13C, a screen in which the inspection level setting pull-downs (415, 417, and 419) for spot-shaped soiling in the corresponding inspection regions in the inspection region settings screen 411 are replaced by sliders is illustrated. As in the first embodiment, these sliders may be applied to the inspection level setting pull-downs (416, 418, and 420) for streak-shaped soiling as well. Note that the slide bars will also be referred to as a critical inspection level setting slide bar, a standard inspection level setting slide bar, or a simple inspection level setting slide bar hereinafter, regardless of whether the soiling is spot-shaped soiling or streak-shaped soiling.

FIG. 15A illustrates the default state of a slider for setting the inspection level for each region. The inspection region settings screen 411 includes sliders for setting an inspection level for each region (1502, 1503, and 1504), as well as a slide bar 1501 indicating the ranges over which the sliders (1502, 1503, and 1504) can move. The inspection region settings screen 411 also includes a slide bar scale 1505 (an example of a scale provided in common) indicating the inspection levels that can be set. The inspection level can be set in nine stages, from 1 to 9.

More specifically, in FIG. 15A, the three sliders 1502 to 1504 are displayed on the single slide bar 1501. The slider 1502 is a slider for setting the critical inspection level. The slider 1503 is a slider for setting the standard inspection level. The slider 1504 is a slider for setting the simple inspection level. A color or pattern by which the type of the inspection region can be identified is added to each slider. FIG. 15A illustrates a state in which the slider 1502 is filled with a pattern 1506, the slider 1503 is filled with a pattern 1507, and the slider 1504 is filled with a pattern 1508.

In the fifth embodiment too, the inspection levels for each inspection region are, from highest to lowest, the critical inspection level, the standard inspection level, and the simple inspection level. FIG. 15A illustrates a state in which the slider 1502 for setting the critical inspection level is set to level 7, the slider 1503 for setting the standard inspection level is set to level 6, and the slider 1504 for setting the simple inspection level is set to level 5. Furthermore, in the example shown in FIG. 15A, because three sliders are provided on the single slide bar, the sliders 1504, 1503, and 1502 are displayed in that order from the left side of the screen.

The sliders (1502, 1503, and 1504) can be moved on the slide bar by an operation instruction, such as being dragged by the user. Furthermore, when the dragging operation by the user ends, each slider is automatically disposed at a position aligned with a tick on the slide bar scale 1505, rather than being disposed between ticks.

In FIG. 15A, the user moves the slider 1502 toward the left side of the screen in order to lower the inspection level of the critical inspection region. Upon doing so, the slider 1503 in contact with the left side of the slider 1502 moves to the left with the slider 1502 as if being physically pushed by the slider 1502. Likewise, the slider 1504 in contact with the left side of the slider 1503 moves to the left with the slider 1503 as if being physically pushed by the slider 1503.

On the other hand, in FIG. 15A, the user moves the slider 1502 to the right in order to raise the inspection level of the critical inspection region. Upon doing so, only the slider 1502 moves toward the right side of the screen.

FIG. 15B illustrates an example of a state in which the user drags a slider 1510 to the left from the state illustrated in FIG. 15A so as to lower the critical inspection level. At this time, the slider 1511 for setting the standard inspection level moves toward the left side of the screen like the slider 1510, as if being pushed to the left by the slider 1510. Furthermore, when the slider 1511 moves to the left, a slider 1512 also moves to the left as if being pushed to the left by the slider 1511.

FIG. 15C illustrates an example of a state in which the user has dragged the slider 1510 from the state illustrated in FIG. 15B to the position of inspection level 9. At this time, only the slider 1510 (displayed as a slider 1513 in FIG. 15C) moves, and a slider 1514 for setting the standard inspection level and a slider 1515 for setting the simple inspection level do not move. This is because when the inspection level of the critical region is changed from level 6 to level 9, the magnitude relationships between the inspection level of the critical region and the inspection levels of the standard region and the simple region are maintained. Therefore, the inspection level of the standard region and the inspection level of the simple region are not changed. Additionally, the sliders for setting each inspection level are arranged on the single slide bar 1501. Accordingly, the user can easily and intuitively recognize that if no other slider is present in the direction of the movement, no other sliders will be affected.

A flowchart illustrating processing for setting the inspection level according to the fifth embodiment is the same as the flowchart of FIG. 14 according to the fourth embodiment, and will therefore not be described. However, in the screen displayed in step S1402, the plurality of sliders are displayed on the single slide bar as illustrated in FIGS. 15A to 15C. Additionally, in step S1412, each setting slider is re-drawn on the single slide bar.

### Actions and Effects

According to the image inspection system 10 of the fifth embodiment, the same effects as those of the fourth embodiment can be achieved.

### Variations

Although the inspection level setting processing is executed in the inspection apparatus 110 in the foregoing embodiments, at least part of the inspection level setting processing may be executed by an external device (e.g., the image forming apparatus 100 or the client PC 130). For example, the inspection settings screen 400 such as that illustrated in FIG. 4 may be displayed on the screen of the client PC 130. The client PC 130 may then send the inspection level information set so as to satisfy the magnitude relationship constraints to the inspection apparatus 110.

The processing of step S612 in the flowchart illustrated in FIG. 6 may be skipped. In other words, assume, for example, that the inspection level of the simple region is set to 1 and the inspection level of the standard region is set to 2. In such a case, even if an instruction is input to change the inspection level of the critical region from 4 to 3, the magnitude relationships between the inspection levels are maintained without changing the inspection level of the simple region and the inspection level of the standard region, which is the processing of step S612. Likewise, the processing of step S615 in the flowchart illustrated in FIG. 6 may be skipped.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-036693, filed Mar. 7, 2025, which is hereby incorporated by reference herein in its entirety.

What is claimed is:

1. An information processing apparatus comprising:
one or more memory devices that store a set of instructions; and
one or more processors that execute the set of instructions to:
accept an input for inspecting an abnormality of an image in a printed material; and
perform control of setting of a different value for each of a plurality of inspection levels respectively corresponding to a plurality of inspection regions, using the accepted input,
wherein the one or more processors execute instructions in the one or more memory devices to set the plurality of inspection levels in such a manner as to maintain a magnitude relationship among the inspection levels.

2. The information processing apparatus according to claim 1,
wherein the one or more processors further execute instructions in the one or more memory devices to display, for each of the plurality of inspection regions, an object indicating an inspection level for selection, and
the accepted input includes a selection of the inspection level indicated by the object.

3. The information processing apparatus according to claim 2,
wherein the one or more processors execute instructions in the one or more memory devices to:
control execution of a first determination as to whether the inspection level included in the accepted input is higher than the inspection level in a set state;
in a case where the first determination indicates that the inspection level included in the accepted input is higher than the inspection level in the set state, set an inspection level for another inspection region in such a manner that the magnitude relationship is maintained, the other inspection region being an inspection region having an inspection level higher than the inspection level included in the accepted input; and
in a case where the first determination indicates that the inspection level included in the accepted input is not higher than the inspection level in the set state, set an inspection level for another inspection region in such a manner that the magnitude relationship is maintained, the other inspection region being an inspection region having an inspection level lower than the inspection level included in the accepted input.

4. The information processing apparatus according to claim 3,
wherein the one or more processors execute instructions in the one or more memory devices to:
in a case where the first determination indicates that the inspection level included in the accepted input is higher than the inspection level in the set state, set the inspection level of the other inspection region one level higher than the inspection level of an inspection region for which the inspection level is one level lower; and
in a case where the first determination indicates that the inspection level included in the accepted input is not higher than the inspection level in the set state, set the inspection level of the other inspection region one level lower than the inspection level of an inspection region for which the inspection level is one level higher.

5. The information processing apparatus according to claim 3,
wherein the one or more processors further execute instructions in the one or more memory devices to control execution of a second determination as to whether the inspection level included in the accepted input enables maintaining the magnitude relationship with the inspection level of the other inspection region in a set state.

6. The information processing apparatus according to claim 5,
wherein the one or more processors execute instructions in the one or more memory devices to:
execute the second determination;
in a case where the second determination indicates that the magnitude relationship can be maintained,
update the inspection level in the set state to the inspection level included in the accepted input, for the inspection region corresponding to the inspection level included in the accepted input, and
set the inspection level of the other inspection region in such a manner that a magnitude relationship with the updated inspection level of the inspection region is maintained; and
in a case where the second determination indicates that the magnitude relationship cannot be maintained,
update the inspection level for the inspection region corresponding to the inspection level included in the accepted input and for the other inspection region in such a manner that the magnitude relationship is maintained, and
the updating of the inspection level included in the accepted input includes updating to a minimum value or a maximum value at which the magnitude relationship can be maintained.

7. The information processing apparatus according to claim 5,
wherein the inspection level indicated by the object includes an inspection level in a range in which the magnitude relationship among the plurality of inspection levels can be maintained, and
the one or more processors execute instructions in the one or more memory devices to skip execution of the second determination.

8. The information processing apparatus according to claim 2,
wherein the object includes a first object that displays selectable inspection levels in list format.

9. The information processing apparatus according to claim 8,
wherein the first object corresponding to a first predetermined inspection region among the plurality of inspection regions includes a second object for identifying an inspection level in a set state for another inspection region among the plurality of inspection regions.

10. The information processing apparatus according to claim 2,
wherein the object includes a third object manipulable to move along a scale indicating selectable inspection levels.

11. The information processing apparatus according to claim 10,
wherein the third object is provided for each of the plurality of inspection regions, and
the object includes a fourth object that, in a case where the third object corresponding to a second predetermined inspection region among the plurality of inspection regions is manipulated to move, constrains a position of the third object corresponding to another inspection region among the plurality of inspection regions in such a manner that the magnitude relationship is maintained.

12. The information processing apparatus according to claim 10,
wherein the scale is provided in common for the plurality of inspection regions, and
the third object for each of the plurality of inspection regions is provided on a single straight line along the scale provided in common.

13. The information processing apparatus according to claim 1, comprising:
an inspection apparatus configured to perform abnormality inspection on the image formed on the printed material.

14. A method for controlling an information processing apparatus, the method comprising:
accepting an input for inspecting an abnormality of an image in a printed material; and
performing control of setting of a different value for each of a plurality of inspection levels respectively corresponding to a plurality of inspection regions, using the accepted input,
wherein the plurality of inspection levels are set in such a manner as to maintain a magnitude relationship among the inspection levels.

15. A non-transitory computer-readable storage medium storing a computer program for causing a computer to execute each step of a method for controlling an information processing apparatus, the method comprising:
accepting an input for inspecting an abnormality of an image in a printed material; and
performing control of setting of a different value for each of a plurality of inspection levels respectively corresponding to a plurality of inspection regions, using the accepted input,
wherein the plurality of inspection levels are set in such a manner as to maintain a magnitude relationship among the inspection levels.
